(19) United States
(12) Patent Application Publication
(10) Pub. No.: US 2009/0107521 A1
(43) Pub. Date: Apr. 30, 2009

(54) CHEMICAL SOLUTION OR PURE WATER FEEDER, SUBSTRATE PROCESSING SYSTEM, SUBSTRATE PROCESSING APPARATUS, OR SUBSTRATE PROCESSING METHOD

(75) Inventors: Tadahiro Ohmi, Miyagi (JP); Akinobu Teramoto, Miyagi (JP); Jiro Yamanaka, Miyagi (JP); Nobutaka Mizutani, Miyagi (JP); Osamu Nakamura, Miyagi (JP); Takaaki Matsuoka, Tokyo (JP); Ryoichi Ohkura, Tokyo (JP)

Correspondence Address: PEARNE & GORDON LLP, 1801 EAST 9TH STREET, SUITE 1200, CLEVELAND, OH, 44114-3108, US

(73) Assignees: TOHOKU UNIVERSITY, Miyagi (JP); TOKYO ELECTRON LIMITED, Tokyo (JP)

(21) Appl. No.: 12/296,989

(22) PCT Filed: Apr. 11, 2007
(86) PCT No.: PCT/JP2007/057971

§ 371 Date: Nov. 20, 2008

(30) Foreign Application Priority Data
Apr. 14, 2006 (JP) 2006-112396

(51) Int. Cl. B08B 3/00; F16L 11/04; F16L 11/20

(52) U.S. Cl. 134/2; 138/125; 134/198

(57) ABSTRACT

By adding a perfluoromonomer to PVDF being a fluororesin to soften it, the oxygen permeability can be significantly reduced and a flexible fluororesin tube can be obtained. The oxygen permeability can also be reduced by providing a nylon tube as an outer layer. The tube is used between a chemical solution or ultrapure water feeder and a chemical solution or ultrapure water utilizing apparatus such as a cleaning apparatus or a wet etching apparatus.

### TECHNICAL FIELD

This invention relates to a chemical solution or pure water feeder, a substrate processing system, a substrate processing apparatus, or a substrate processing method, using a resin pipe for transporting a process liquid such as ultrapure water (UPW) or a chemical solution.

### BACKGROUND ART

Generally, when manufacturing electronic devices such as semiconductor devices or liquid crystal display devices, ultrapure water (UPW) (including ultrapure water containing hydrogen or ozone, i.e. so-called hydrogen water or ozone water) is often transported and supplied through resin pipes in addition to various chemical solutions and so on. The reason for using the ultrapure water in manufacturing the semiconductor devices or the like as described above is that if a large amount of oxygen is contained in the form of dissolved oxygen in water used in a cleaning process or the like, a natural oxide film is formed due to such dissolved oxygen. Recently, however, it has been pointed out that even if ultrapure water is used, a natural oxide film is likewise formed, and therefore, it has been attempted to thoroughly remove oxygen, particles, and metal components contained in ultrapure water.

For example, when forming a semiconductor device using a silicon crystal, a natural oxide film (SiOx) is formed on the silicon surface if oxygen and water coexist. Particularly, it has also been pointed out that if oxygen is contained in an aqueous solution, the silicon surface is oxidized and further etched, resulting in an increase in surface microroughness.

In recent years, attention has been paid to the Si (110) crystal surface with a greater current driving capability for a PMOSFET as compared with the Si (100) crystal surface. However, this surface is etched more severely in an aqueous solution as compared with the Si (100) surface. Accordingly, although the Si surface is normally cleaned by wet cleaning using an aqueous solution, it is necessary not to incorporate oxygen into the aqueous solution in that event.

Herein, it has been pointed out that the incorporation of oxygen into an aqueous solution occurs not only during a cleaning process or the like, but also through a resin pipe constituting a transport line for ultrapure water, a chemical solution, or the like. For reducing the incorporation of oxygen into the transport line, Japanese Unexamined Patent Application Publication (JP-A) No. 2004-322387 (Patent Document 1) discloses a tube in which a heat-shrinkable belt-like film made of a resin adapted to suppress permeation of gas is helically wound around a tube body so that portions of the belt-like film partly overlap each other.

Further, in Patent Document 1, the wound belt-like film is heated in a vacuum atmosphere at a temperature lower than a melting point of the belt-like film so as to be heat-shrunk and fusion-bonded, thereby excluding air between the portions of the wound film. Further, Patent Document 1 discloses to use, as the tube body, a fluororesin such as a tetrafluoroethylene-perfluoroalkoxyethylene copolymer resin (PFA), a tetrafluoroethylene resin (PTFE), or a tetrafluoroethylene-hexafluoropropylene copolymer (FEP). Further, it also discloses to use, as the belt-like film, polyvinylidene chloride having low gas permeability and having heat shrinkability. In this manner, by forming a gas permeation suppression outer cover layer using the belt-like film, it is possible to prevent a gas permeated through the outer cover layer from dissolving into ultrapure water or a chemical solution flowing in the tube.

On the other hand, Japanese Patent Application No. 2004-299808 (Patent Document 2) discloses, as a pipe for use in a semiconductor manufacturing apparatus, a liquid crystal manufacturing apparatus, or the like, a fluororesin double tube in which fluororesins are laminated in two layers. The fluororesin double tube disclosed in Patent Document 2 comprises an inner layer tube and an outer layer tube, wherein the inner layer tube is made of a fluororesin excellent in corrosion resistance and chemical resistance (e.g. a tetrafluoroethylene-perfluoroalkylvinylether copolymer (PFA), a tetrafluoroethylene-hexafluoropropylene copolymer (FEP), or a tetrafluoroethylene-ethylene copolymer (ETFE)), while, the outer layer tube is made of a fluororesin capable of suppressing permeation of gas (e.g. polyvinylidene fluoride (PVDF)), and the inner layer tube and the outer layer tube are fusion-bonded to each other.

The fluororesin double tube shown in Patent Document 2 has advantages in that it has the excellent corrosion resistance, chemical resistance, and gas permeation preventing properties and, further, the inner layer tube and the outer layer tube can be firmly bonded together.
Patent Document 1: Japanese Unexamined Patent Application Publication (JP-A) No. 2004-322387
Patent Document 2: Japanese Patent Application No. 2004-299808

### DISCLOSURE OF THE INVENTION

### Problem to be Solved by the Invention

Patent Document 1 discloses that the piping is carried out using the disclosed tube, the dissolved oxygen amount in ultrapure water flowing in the pipe is measured by a dissolved oxygen meter, and the dissolved oxygen amount can be reduced to 3.5 ppb.

On the other hand, Patent Document 2 discloses the fluororesin double tube in which the peel strength between the inner layer tube and the outer layer tube is 3.0N/m or more. Further, Patent Document 2 defines an oxygen permeability and an oxygen permeability coefficient and points out that the oxygen permeability and the oxygen permeability coefficient can be reduced. Herein, Patent Document 2 defines, as the oxygen permeability, an oxygen permeability per 24 hours (day) (grams/24 hr), while, defines, as the oxygen permeability coefficient, a coefficient given by (grams·mil/100 in²·24 hr atm). That is, the oxygen permeability and the oxygen permeability coefficient are given by the following formulas (1) and (2), respectively.

Oxygen Permeability (grams/24 hr)=(Dissolved Gas Concentration (g/l)×Volume in Tube (I)/Residence Time in Tube (24 hr) (1)

Oxygen Permeability Coefficient (grams·mil/100 in²·24 hr·atm)=(Oxygen Permeability×Tube Wall Thickness (mil))/(Tube Surface Area (100 in²)×Gas Differential Pressure (atm)) (2)

Patent Document 2 discloses that the fluororesin double tube having a PFA layer and a PVDF layer as the inner layer tube and the outer layer tube, respectively, exhibits an oxygen permeability coefficient of 0.135 (grams·mil/100 in²·24 hr atm) when no hydrophilic treatment is applied between both layers, while, exhibits an oxygen permeability coefficient of 0.025 (grams·mil/100 in²·24 hr atm) when the hydrophilic treatment is applied between both layers. Since the oxygen permeability coefficient is 1.300 (grams·mil/100 in²·24 hr atm) in the case of a PFA layer alone, the fluororesin double tube shown in Patent Document 2 can significantly reduce the oxygen permeability coefficient.

On the other hand, the dissolved oxygen amount allowed during cleaning is 10 ppb or less in a recent semiconductor manufacturing apparatus, liquid crystal manufacturing apparatus, or the like and, for enabling it, the oxygen permeability is required to be 5×10⁶ (molecules·cm/cm² sec Pa) or less.

However, with the tube shown in Patent Document 1, the dissolved oxygen amount cannot be set to 3.5 ppb or less, much less 1 ppb or less. On the other hand, with the technique described in Patent Document 2, the required oxygen permeability cannot be accomplished even if the hydrophilic treatment is applied to the inner layer tube. In other words, in order to achieve the oxygen permeability coefficient of 0.025 (grams·mil/100 in²·24 hr·atm) in Patent Document 2, it is necessary to perform a hydrophilic treatment of, for example, preparing a mixed solution of metal sodium, naphthalene, and THF (tetrahydrofuran), then, after immersing the inner layer tube in the mixed solution, removing the naphthalene by methanol cleaning, and then removing sodium fluoride by rinsing. Therefore, according to the technique of Patent Document 2, there is a drawback that the complicated operation is required for obtaining a tube having the required oxygen permeation properties and, further, since the PVDF used for forming the outer layer tube is not flexible, the piping is difficult.

It is an object of this invention to provide a chemical solution/pure water feeder that can achieve a dissolved oxygen amount of 10 ppb or less by improving a pipe.

It is another object of this invention to provide a substrate processing apparatus, a substrate processing system, or a substrate processing method, which includes a pipe containing a fluororesin and capable of achieving a required dissolved oxygen amount and oxygen permeability coefficient.

It is still another object of this invention to provide a method of manufacturing an electronic device using a substrate processing system including a pipe made of a fluororesin that is flexible.

### Means for Solving the Problem

According to a first aspect of this invention, there is provided a chemical solution or ultrapure water feeder comprising a degasifier for removing gas from a chemical solution or ultrapure water and a resin pipe having an oxygen permeability coefficient of 5×10⁶ [molecules·cm/cm² sec Pa] or less.

Preferably, the oxygen permeability coefficient of the resin pipe is 2×10⁶ [molecules·cm/cm² sec Pa] or less.

Preferably, the resin pipe is integrally formed of two or more kinds of materials having different compositions.

Alternatively, it is preferable that the resin pipe comprises a softened PVDF layer or a nylon layer.

It is also preferable that the resin pipe is formed by combination of a softened PVDF layer or a nylon layer and a layer made of one of ETFE, PTFE, PVDC, FEP, and PFA.

Preferably, an inner surface of the resin pipe is made of a material having resistance to one of an alkaline aqueous solution, an acidic aqueous solution, a neutral aqueous solution, and an organic solvent.

There is provided a feeder wherein a dissolved oxygen concentration in the chemical solution or the ultrapure water can be maintained at 10 ppb or less by using the resin pipe.

According to this invention, there is provided a processing system comprising any one of the above-mentioned feeders and a processing apparatus for processing a substrate using the chemical solution or the ultrapure water supplied from the feeder through the resin pipe.

In the above-mentioned processing system, permeation of at least one of nitrogen gas, oxygen gas, argon gas, and carbon dioxide gas in an atmosphere of the resin pipe into the resin pipe is suppressed. The ultrapure water is hydrogen water containing hydrogen and permeation of oxygen gas to the outside of the resin pipe is suppressed.

Herein, no consideration is given to realizing a supply system of an aqueous solution (a non-aqueous solution is also applicable) with reduced oxygen concentration. To be concrete, currently, a PFA tube is often used in a chemical solution supply system, but oxygen molecules that permeate the PFA tube are about 1.56×10⁷ [molecules·cm/cm² sec Pa] and it is not possible to achieve the order of 10⁶.

In this invention, it is possible to realize a chemical solution supply system/wet cleaning apparatus that can reduce an oxygen concentration in an aqueous solution, to which the surface is exposed during cleaning or the like, to about the order of 10⁶ in terms of the number of oxygen molecules.

Therefore, according to another mode of this invention, there is obtained a chemical solution feeder comprising a degasifier for removing gas from a chemical solution and the pipe described above.

According to another mode of this invention, there is obtained a chemical solution feeder wherein a dissolved oxygen concentration in a chemical solution is 10 ppb or less.

### EFFECT OF THE INVENTION

According to this invention, by optimizing the composition/structure of a resin material, there is formed a pipe having resistance to an aqueous solution/non-aqueous solution to be supplied and, further, having a small oxygen (gas) permeability. Further, in this invention, it is possible to constitute a chemical solution supply system with a small amount of oxygen by performing degassing of a chemical solution and using the above pipe. Further, it is also possible to constitute a wet processing apparatus by combining a wet processing container with a low oxygen concentration and the above chemical solution supply system. Accordingly, in this invention, it is possible to form a pipe with a very small amount of gas permeation and thus to constitute a chemical solution supply system/wet cleaning apparatus with a low concentration of gas, particularly oxygen.

This makes it possible not only to suppress permeation of O₂, CO₂, or the like from atmospheric air, but also to suppress permeation of hydrogen from hydrogen water to the outside of a pipe or permeation of gas from hydrochloric acid, fluoric acid, or the like to the outside of a pipe.

### BRIEF DESCRIPTION OF THE DRAWINGS

FIG. 1 is a schematic perspective view illustrating one example of a tube for use in a piping system of this invention.

FIG. 2 is a sectional view illustrating another example of a tube for use in a piping system of this invention.

FIG. 3 is a diagram illustrating a measurement system for measuring the properties of a tube for use in this invention.

FIG. 4 is a graph showing permeated amounts of oxygen measured by the measurement system illustrated in FIG. 3.

FIG. 5 is a diagram showing the measurement results obtained using the measurement system illustrated in FIG. 3.

FIG. 6 is a diagram schematically illustrating a substrate processing apparatus and a substrate processing system according to an embodiment of this invention.

FIG. 7 is a diagram schematically illustrating a substrate processing apparatus and a substrate processing system according to another embodiment of this invention.

### DESCRIPTION OF SYMBOLS

10 softened PVDF tube
12 PFA tube
14 nylon tube
16 adhesive layer
100, 200 substrate processing system
101, 201 cleaning room
102, 103, 202, 203 process liquid input port
104, 105, 204, 205 resin pipe
106, 206 nozzle
107, 207 processing substrate
108, 208 rotary stage
111, 211 chemical solution/ultrapure water feeder
112, 212 degasifier
113 compounded chemical solution tank
114 pump
115-1 to 115-6, 215-1 to 215-2 valves
120, 130, 220, 230 inter-apparatus pipe
117-1 to 117-3, 118-1 to 118-9 pipes
217-1 to 217-3, 218-1 to 218-3 pipes

### BEST MODE FOR CARRYING OUT THE INVENTION

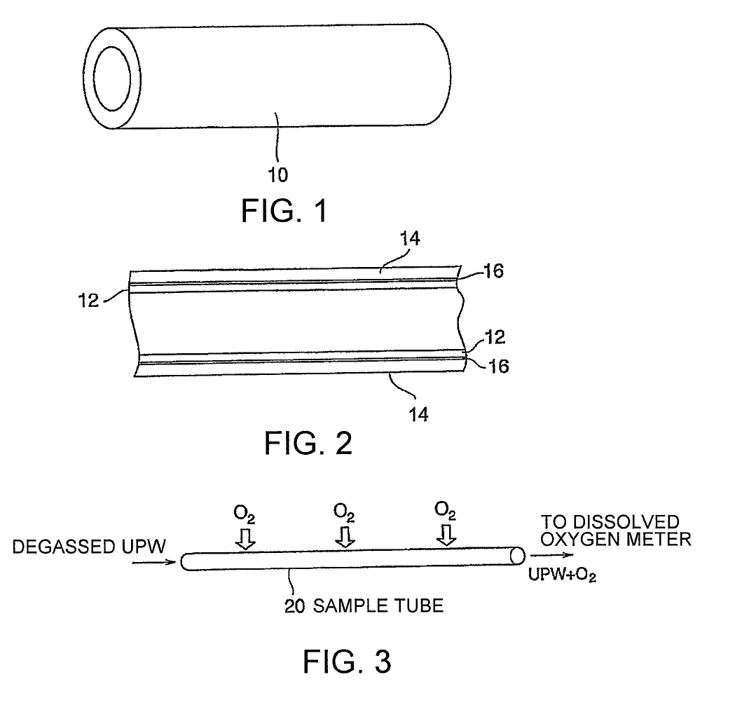

Referring to FIG. 1, a description will be given of a tube for use in a chemical solution/pure water processing apparatus, a substrate processing apparatus, or a substrate processing system according to this invention. An illustrated tube 10 is formed by a single layer of PVDF (polyvinylidene fluoride) having been subjected to softening treatment and has a flexural modulus of 1200 MPa. Normal PVDF has a flexural modulus of 2000 MPa and is not flexible and, thus, a tube made of the normal PVDF is not suitable as a resin pipe that is subjected to processing such as bending. Therefore, actually, the fact is that a PVDF pipe is not used as a pipe for a chemical solution/pure water processing apparatus or the like for use in manufacturing semiconductor devices or the like.

In view of this, the illustrated PVDF tube 1 0 has been subjected to the softening treatment that weakens the intermolecular force by adding a perfluoromonomer. As a result, it has been confirmed that the softened PVDF tube 10 is flexible and can be freely bent to enable resin piping as required, and thus can be employed as a pipe for a chemical solution/pure water processing apparatus or the like of a semiconductor manufacturing apparatus or a liquid crystal manufacturing apparatus.

Further, it has been found that the softened PVDF tube 10 has extremely excellent permeation preventing properties, i.e. an extremely low permeability coefficient, with respect to gas (oxygen, nitrogen) as compared with a tube made of PFA.

On the other hand, it has been found that a nylon tube not used at all as a pipe for a semiconductor manufacturing apparatus, a liquid crystal manufacturing apparatus, or the like also exhibits an extremely low permeability coefficient as compared with the PFA single-layer structure tube. That is, it has been experimentally confirmed that the PVDF tube 10 illustrated in FIG. 1 may be replaced with a single-layer nylon tube.

Referring to FIG. 2, another example of a tube for use in an embodiment of this invention has a three-layer structure. The illustrated tube comprises a PFA tube 12 forming an inner layer and a nylon tube 14 forming an outer layer, wherein the PFA tube 12 and the nylon tube 14 are bonded together by an adhesive layer 16.

In this structure, the inner layer is formed by the PFA tube 12 made of the fluororesin adapted to suppress permeation of gas and being inactive and thus excellent in resistance to ultrapure water, chemical solutions, and gas. However, the permeation of gas (oxygen, nitrogen) cannot be fully prevented only by the PFA tube 12 and thus it is not possible to constitute a resin pipe having the required properties using only the PFA tube 12.

Therefore, in the illustrated example, the outer layer is made of nylon 14 which is not used in this type of semiconductor manufacturing apparatus and the nylon tube 14 and the PFA tube 12 are bonded together by the adhesive layer 16. Then, much better results are obtained as compared with the case of a PFA tube single layer. That is, since nylon is normally weak to alkali and is easily discolored, it is considered unsuitable for a pipe of a semiconductor manufacturing apparatus or the like, but it has been found through experiments by the present inventors that nylon is effective for reducing the oxygen permeability. Specifically, the PFA tube 12 having a thickness of 0.2 mm and the nylon tube 14 having a thickness of 0.7 mm are bonded together by the fluorine-based adhesive layer 16 having a thickness of 0.1 mm.

For clarifying the foregoing fact, the permeability coefficient measurement results will be explained. At first, referring to FIG. 3, a description will be given of a permeability coefficient measurement system used in an experiment according to this invention. As illustrated in FIG. 3, through a degassing filter (not illustrated), ultrapure water (UPW) (degassed UPW) is supplied to a tube that is set as a sample tube 20. In the illustrated measurement system, the permeation of gas into the sample tube 20 is proportional to a contact area and a contact time between the gas and the sample tube 20, a pressure, and a temperature and is inversely proportional to a thickness. Therefore, the permeability (permeability coefficient) per unit time, unit pressure, and unit thickness is calculated by the following formula (3).

Permeability Coefficient=(Permeated Substance Amount×Thickness of Sample)/(Area of Sample×Contact Time×Permeated Substance Pressure Differential)=(molecules·cm)/(cm²·sec·Pa) (3)

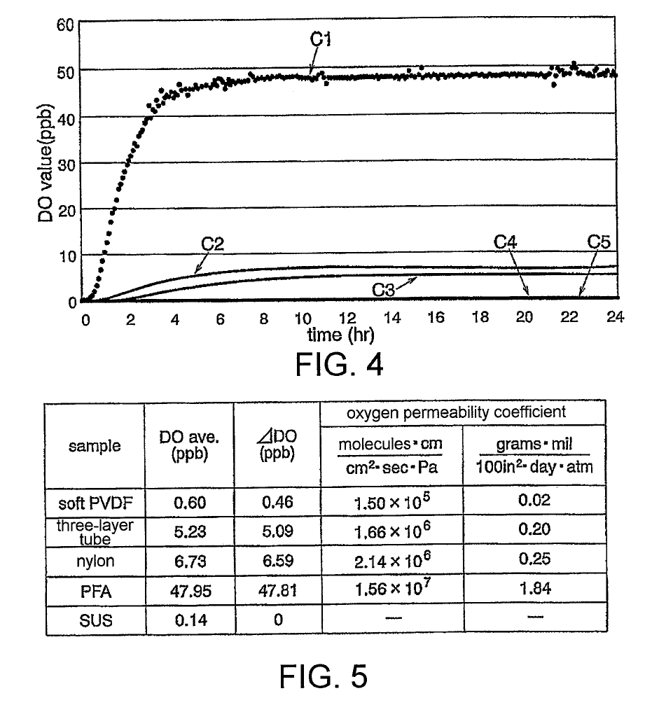

FIG. 4 shows the measurement results obtained using the measurement system illustrated in FIG. 3. Herein, each sample tube 20 has an outer diameter of 8 mm, an inner diameter of 6 mm, and a length of 1.5 m. In the illustrated example, the measurement results are obtained by supplying 23° C. UPW to the measurement system illustrated in FIG. 3 at a flow rate of 1 l/min and, herein, there are shown the measurement results of dissolved oxygen (DO) when an oxygen load of 3 kgf/cm² is applied to the sample tube 20.

In FIG. 4, a characteristic curve C1 represents the permeability of a PFA single-layer tube and a characteristic curve C2 represents time-dependent changes (for 24 hours) in permeability of a nylon single-layer tube. Further, a characteristic curve C3 represents the permeability of a tube formed by stacking three layers, i.e. a PFA layer, an adhesive layer, and a nylon layer, like that illustrated in FIG. 2 and having an outer diameter of 8 mm, an inner diameter of 6 mm, and a length of 1.5 m. A characteristic curve C4 represents the permeability of a softened PVDF tube like that illustrated in FIG. 1. Note that a characteristic curve C5 in FIG. 4 represents, for reference, the permeability of a stainless tube (SUS) incapable of flexible piping.

As is clear from FIG. 4, it is understood that the softened PVDF tube (C4), the three-layer structure tube (C3), and the nylon tube (C2) each exhibit an oxygen permeability of 10 ppb or less even after the lapse of 24 hours and thus have extremely excellent properties as compared with the PFA single-layer tube of which the oxygen permeability reaches near 50 ppb. It is further understood that, among them, the oxygen permeability is the least in the case of the softened PVDF tube (C4) and then gradually increases in the order of the three-layer structure tube (C3) and the nylon tube (C2). Further, the softened PVDF tube exhibits a low oxygen permeability equivalent to that of the stainless tube (SUS).

Next, referring to FIG. 5, there are shown measured values of oxygen permeability coefficients of the above tubes. Herein, the average value during 16 to 20 hours is given as dissolved oxygen (DO) and, further, the change amount of dissolved oxygen is given as ΔDO in Table 1 assuming that the oxygen amount remaining in UPW is 0.14 ppb. Further, there are also shown oxygen permeability coefficients calculated by the formulas (3) and (2).

As is clear from Table 1, it is understood that, as compared with an oxygen permeability coefficient (1.56×10⁷: 1.84) of the PFA single-layer tube, the nylon tube, the three-layer tube, and the softened PVDF tube each have a much smaller oxygen permeability coefficient (i.e. on the order of 10⁷ or less). That is, the two oxygen permeability coefficients of the softened PVDF tube, the three-layer tube, and the nylon tube are (1.50×10⁵: 0.02), (1.66×10⁶: 0.20), and (2.14×10⁶: 0.25) (units omitted), respectively, and thus are smaller by one digit as compared with the PFA tube, and particularly, the softened PVDF tube has the oxygen permeability coefficient which is smaller by two digits than that of the PFA tube.

As the example of the foregoing pipe containing nylon, the description has been given of such a tube in the combination of nylon and PFA. However, nylon may be combined with another fluororesin such as, for example, ETFE, PTFE, PVDC, or FEP. Alternatively, it is possible to combine softened PVDF with ETFE, PTFE, PVDC, FEP, PFA, or the like. In this case, it is preferable to use, as an inner layer, a material having resistance to one of an alkaline aqueous solution, an acidic aqueous solution, a neutral aqueous solution, and an organic solvent.

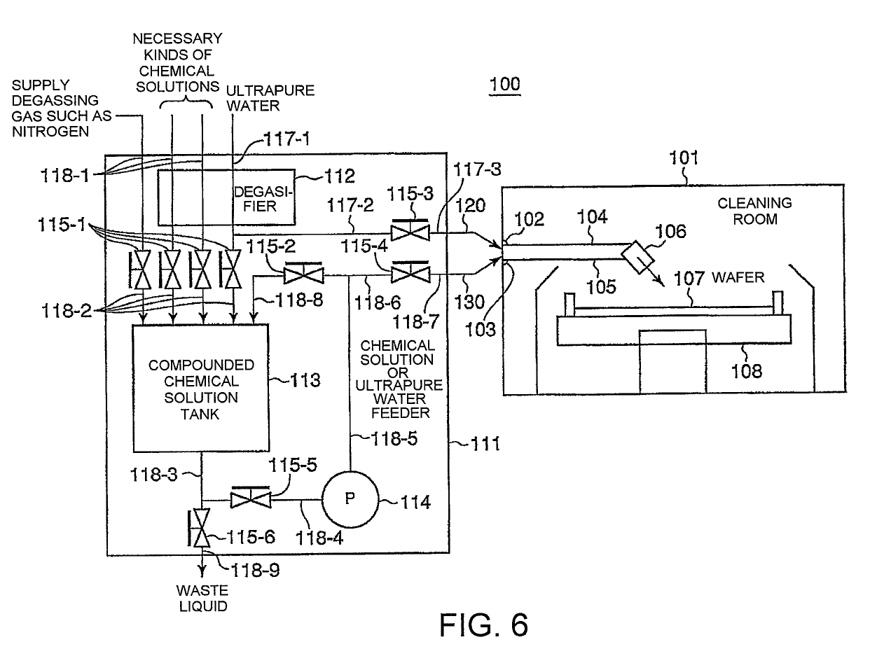

Referring to FIG. 6, a description will be given of a chemical solution or pure water feeder, a substrate processing system, a substrate processing apparatus, and a substrate processing method according to an embodiment of this invention. In the illustrated example, there is shown a substrate processing system for cleaning a substrate such as a semiconductor substrate or an FDP substrate, wherein the system 100 includes a cleaning room 101 corresponding to a substrate processing apparatus. The substrate processing apparatus has process liquid input ports 102 and 103 connected to a process liquid supply source. Of the input ports, one 102 is for introducing ultrapure water and the other 103 is for introducing a chemical solution. Resin pipes 104 and 105 according to this invention each having an oxygen permeability coefficient of 5×10⁶ [molecules·cm/cm² sec Pa] or less, preferably 2×10⁶ [molecules·cm/cm² sec Pa] or less are connected to the ports 102 and 103, respectively, and the pipes are connected to a nozzle 106.

From the nozzle 106, one or both of the ultrapure water and the chemical solution transported through the resin pipes 104 and 105 are discharged onto a processing substrate (in this case, a semiconductor wafer) 107 held on a rotary stage 108, thereby cleaning the substrate surface. The process liquid supply source connected to the process liquid input ports 102 and 103 of the substrate processing apparatus 101 may be a tank or the like transported from a plant for supplying a degassed process liquid or may be a chemical solution/ultrapure water feeder 111 illustrated in this embodiment.

In this embodiment, the chemical solution/ultrapure water feeder 111 comprises a degasifier 112, a compounded chemical solution tank 113, a pump 114, valves 115-115-6, and resin pipes 117-1 to 117-3 and 118-1 to 118-9 according to this invention each having an oxygen permeability coefficient of 5×10⁶ [molecules·cm/cm² sec Pa] or less, preferably 2×10⁶ [molecules·cm/cm² sec Pa] or less.

The ultrapure water is introduced from the resin pipe 117-1, passes through the degasifier 112 so as to be degassed, and then is discharged from the outlet-portion pipe 117-3 through the pipe 117-2 and the valve 115-3, while, is also supplied into the tank 113 through the valve 115-1 and the pipe 118-2.

Necessary kinds of chemical solutions are introduced from the resin pipes 118-1, degassed in the degasifier 112, and then supplied into the tank 113 through the valves 115-1 and the pipes 118-2, while, a degassing gas such as nitrogen is also supplied into the tank 113 through the pipe 118-1, the valve 115-1, and the pipe 118-2. The degassed and compounded chemical solution is sent to the pump 114 from the tank 113 through the pipe 118-3 and the valve 115-5, while, part of it is discarded through the valve 115-6 and the discard-portion pipe 118-9. The pump 114 discharges the degassed/compounded chemical solution from the outlet-portion pipe 118-7 through the pipes 118-5 and 118-6 and the valve 115-4, while, returns the chemical solution through the valve 115-2 and the pipe 118-8 if necessary.

The outlet-portion pipes 117-3 and 118-7 of the chemical solution/ultrapure water feeder 111 are respectively connected to the process liquid input ports 102 and 103 of the substrate processing apparatus 101 through resin pipes 120 and 130 according to this invention each having an oxygen permeability coefficient of 5×10⁶ [molecules·cm/cm² sec Pa] or less, preferably 2×10⁶ [molecules·cm/cm² sec Pa] or less, and the ultrapure water and the chemical solution are supplied to the substrate processing apparatus 101 through the resin pipes 120 and 130, respectively.

In this invention, the inter-apparatus connecting pipes 120 and 130 may be regarded as “process liquid supply pipes” or may be regarded as part of the process liquid supply source. In the latter case, “process liquid supply pipes” are the pipes 104 and 105 in the substrate processing apparatus 101. Likewise, the inter-apparatus connecting pipes 120 and 130 may be regarded as part of the substrate processing apparatus and, in this case, “resin pipes” are the pipes 117 and 118 in the chemical solution/ultrapure water feeder 111.

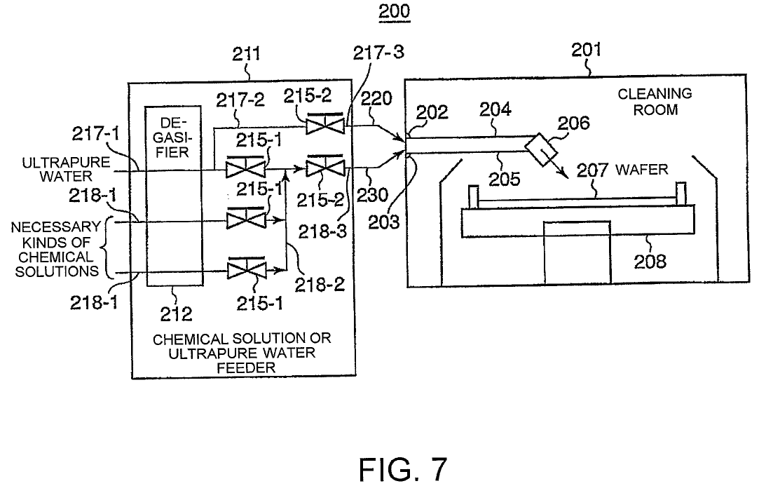

Referring to FIG. 7, a substrate processing system according to another embodiment of this invention is likewise an example of a substrate processing system for cleaning a substrate such as a semiconductor substrate or an FDP substrate, wherein the system 200 includes a cleaning room 201 corresponding to a substrate processing apparatus. The structure of the substrate processing apparatus 201 is the same as the example of FIG. 6, wherein there are provided process liquid input ports 202 and 203 connected to a process liquid supply source and one 202 of the input ports is for introducing ultrapure water while the other 203 is for introducing a chemical solution. Resin pipes 204 and 205 according to this invention each having an oxygen permeability coefficient of 5×10⁶ [molecules·cm/cm² sec Pa] or less, preferably 2×10⁶ [molecules·cm/cm² sec Pa] or less are connected to the ports, respectively, and the pipes are connected to a nozzle 206. From the nozzle 206, one or both of the ultrapure water and the chemical solution transported through the pipes 204 and 205 are discharged onto a processing substrate (in this case, a semiconductor wafer) 207 held on a rotary stage 208, thereby cleaning the substrate surface.

A chemical solution/ultrapure water feeder 211 comprises a degasifier 212, valves 215-1 to 215-2, and resin pipes 217-1 to 217-3 and 218-1 to 218-3 according to this invention each having an oxygen permeability coefficient of 5×10⁶ [molecules·cm/cm² sec Pa] or less, preferably 2×10⁶ [molecules·cm/cm² sec Pa] or less. The ultrapure water is introduced from the resin pipe 217-1, degassed in the degasifier 212, and then discharged from the outlet-portion pipe 217-3 through the pipe 217-2 and the valve 215-2, while, can also be used for mixing into the chemical solution through the valve 215-1. Necessary kinds of chemical solutions are introduced from the resin pipes 218-1, degassed in the degasifier 212, compounded through the valves 215-1 and the pipe 218-2, and then transported to the valve 215-2. The degassed/compounded chemical solution is discharged from the outlet-portion pipe 218-3 through the valve 215-2. The outlet-portion pipes 217-3 and 218-3 of the chemical solution/ultrapure water feeder 211 are respectively connected to the process liquid input ports 202 and 203 of the substrate processing apparatus 201 through resin pipes 220 and 230 according to this invention each having an oxygen permeability coefficient of 5×10⁶ [molecules·cm/cm² sec Pa] or less, preferably 2×10⁶ [molecules·cm/cm² sec Pa] or less, and the ultrapure water and the chemical solution are supplied to the substrate processing apparatus 201 through the resin pipes 220 and 230, respectively.

In each of the examples of FIGS. 6 and 7, the inter-apparatus pipes 120, 130, 220, 230 are exposed to clean room air, but since these inter-apparatus pipes 120, 130, 220, 230 are in the form of the resin pipes according to this invention each having the oxygen permeability coefficient of 5×10⁶ [molecules·cm/cm² sec Pa] or less, preferably 2×10⁶ [molecules·cm/cm² sec Pa] or less, it is possible to prevent the incorporation of oxygen into the degassed ultrapure water and/or chemical solution and thus to prevent as much as possible the adverse influence of oxygen in the substrate processing in the processing apparatus.

On the other hand, the substrate processing apparatus 101, 201 and the feeder 111, 211 normally introduce the clean room air through filters such as HEPA, but the internal resin pipes 104, 105, 204, 205, 117-1 to 117-3, 118-1 to 118-9, 217-1 to 217-3, 218-1 to 217-3 are also in the form of the resin pipes according to this invention each having the oxygen permeability coefficient of 5×10⁶ [molecules·cm/cm² sec Pa] or less, preferably 2×10⁶ [molecules·cm/cm² sec Pa] or less, it is possible to prevent the incorporation of oxygen into the degassed ultrapure water and/or chemical solutions. Note that when sealing one or both of the substrate processing apparatus 101, 201 and the feeder 111, 211 and introducing nitrogen gas, conventional resin pipes may be used as resin pipes therein, but it is more preferable to use the resin pipes according to this invention for the following reasons.

That is, by reducing gas species, dissolution of which is unwanted, around the pipe and using the pipe that does not easily allow gas permeation therethrough, the rate itself of gas diffusing through the pipe and dissolving into the liquid decreases and thus the dissolution amount can be further reduced. That is, the pipe serves to suppress the rate of gas dissolution and further the existing amount of dissolving gas is reduced due to atmosphere substitution by the introduction of nitrogen gas, so that the effect is further enhanced. Further, by using the pipe of this invention to reduce the dissolution rate of gas, it is possible to reduce the amount of gas used for substituting the atmosphere in the apparatus and thus not to increase the sealability of the apparatus and, therefore, it is also possible to easily perform the concentration control of the atmosphere.

Further, from the same point of view, if the inter-apparatus pipes 120, 130, 220, 230 are placed in a sealed body and nitrogen gas or the like is introduced, it is possible to further reduce the amount of dissolved oxygen.

FIGS. 6 and 7 illustrate only the linear pipes, but, actually, there occurs a case where pipes should be arranged so as to be bent inside and between apparatuses. In this case, if the flexural modulus is set to 1800 MPa or less, the pipes can be practically used as flexible resin pipes. Since softened PVDF (polyvinylidene fluoride) and nylon described in this invention have flexural moduli of 1200 MPa and 500 MPa, respectively, the piping can be carried out with no practical problem. On the other hand, normal PVDF not softened has a flexural modulus of 2000 MPa and thus is not flexible and, therefore, a tube made of the normal PVDF is not suitable as a resin pipe that is subjected to processing such as bending. Since the resin pipes according to this invention each have a flexural modulus of 1800 MPa or less, they can be put to practical use as flexible resin pipes.

In each of the substrate processing apparatuses illustrated in FIGS. 6 and 7, all the pipes are formed by the resin pipes according to this invention. However, only part of the pipes may be formed by the resin pipes according to this invention.

### INDUSTRIAL APPLICABILITY

This invention is applicable to a chemical solution supply system constituted by combining a degasifier for removing gas from a chemical solution and pipes and is also applicable not only to a processing system including such a chemical solution supply system, but also to a substrate processing apparatus and a substrate processing method, and is further applicable to the manufacture of electronic devices including such a substrate processing method in processes thereof.

1. A chemical solution or pure water feeder comprising a degasifier for removing gas from a chemical solution or pure water and a resin pipe having an oxygen permeability coefficient of 5×10⁶ [molecules·cm/cm² sec Pa] or less.

2. A chemical solution or pure water feeder according to claim 1, wherein the oxygen permeability coefficient of said resin pipe is 2×10⁶ [molecules·cm/cm² sec Pa] or less.

3. A chemical solution or pure water feeder according to claim 1, wherein said resin pipe is integrally formed of two or more kinds of materials having different compositions.

4. A chemical solution or pure water feeder according to claim 1, wherein said resin pipe comprises a softened PVDF layer.

5. A chemical solution or pure water feeder according to claim 1, wherein said resin pipe comprises a nylon layer.

6. A chemical solution or pure water feeder according to claim 3, wherein said resin pipe is formed by combination of a softened PVDF layer or a nylon layer and a layer made of one of ETFE, PTFE, PVDC, FEP, and PFA.

7. A chemical solution or pure water feeder according to claim 1, wherein an inner surface of said resin pipe is made of a material having resistance to one of an alkaline aqueous solution, an acidic aqueous solution, a neutral aqueous solution, and an organic solvent.

8. A chemical solution or pure water feeder according to claim 1, wherein a dissolved oxygen concentration in said chemical solution or said pure water can be maintained at 10 ppb or less by using said resin pipe.

9. A chemical solution or pure water feeder according to claim 1, wherein said pure water is hydrogen water containing hydrogen and permeation of hydrogen gas to the outside of said resin pipe is suppressed.

10. A substrate processing system comprising the chemical solution or pure water feeder according to claim 1 and a processing apparatus for processing a substrate using the chemical solution or the pure water supplied from said feeder through said resin pipe.

11. A substrate processing system according to claim 10, wherein permeation of at least one of nitrogen gas, oxygen gas, argon gas, and carbon dioxide gas in an atmosphere of said resin pipe into said resin pipe is suppressed.

12. A substrate processing apparatus comprising a substrate processing section for processing a substrate with a degassed process liquid, a process liquid supply source of said process liquid, and a process liquid supply pipe interposed between said process liquid supply source and said substrate processing section, said substrate processing apparatus wherein
said process liquid supply pipe is a resin pipe having an oxygen permeability coefficient of 5×10⁶ [molecules·cm/cm² sec Pa] or less.

13. A substrate processing apparatus according to claim 12, wherein the oxygen permeability coefficient of said resin pipe is 2×10⁶ [molecules·cm/cm² sec Pa] or less.

14. A substrate processing apparatus according to claim 12, wherein said resin pipe is integrally formed of two or more kinds of materials having different compositions.

15. A substrate processing apparatus according to claim 12, wherein said resin pipe comprises a softened PVDF layer.

16. A substrate processing apparatus according to claim 12, wherein said resin pipe comprises a nylon layer.

17. A substrate processing apparatus according to claim 14, wherein said resin pipe is formed by combination of a softened PVDF layer or a nylon layer and a layer made of one of ETFE, PTFE, PVDC, FEP, and PFA.

18. A substrate processing apparatus according to claim 12, wherein an inner surface of said resin pipe is made of a material having resistance to one of an alkaline aqueous solution, an acidic aqueous solution, a neutral aqueous solution, and an organic solvent.

19. A substrate processing apparatus according to claim 12, wherein said process liquid is hydrogen water containing hydrogen and permeation of hydrogen gas to the outside of said resin pipe is suppressed.

20. A substrate processing method wherein a substrate is processed using the substrate processing system according to claim 10.

21. A substrate processing method wherein a substrate is processed using the substrate processing apparatus according to claim 12.

22. An electronic device manufacturing method comprising a substrate processing step by the substrate processing method according to claim 20 or 21.
